(19) United States
(12) Patent Application Publication
(10) Pub. No.: US 2006/0036869 A1
(43) Pub. Date: Feb. 16, 2006

(54) Methods and systems that provide user access to computer resources with controlled user access rights

(76) Inventor: Bill Faught, Mountain View, CA (US)

Correspondence Address: HELLER EHRMAN LLP, 275 MIDDLEFIELD ROAD, MENLO PARK, CA, 94025-3506, US

(21) Appl. No.: 10/918,856

(22) Filed: Aug. 12, 2004

(51) Int. Cl. H04L 9/00

(52) U.S. Cl. 713/182

(57) ABSTRACT

A method of is provided for granting correct access to computer system resources. Correct access is based on a description of business processes, roles, and the assignment of roles to business processes. Such a definition is stored in an enterprise model. To compute the correct security profiles, the model is analyzed to identify security profiles that meet role and business process assignments for each user of the computer system. An iteration is done through possible security profiles to identify potential best matches of profiles that provides access to the resources required to implement the business process by one or more users. A subset of the security profiles is created on the associated business processes response based on the lowest risk assessments.

### BACKGROUND OF THE INVENTION

1. Field of the Invention

This invention relates generally to methods and systems that provide users access to computer resources, and more particularly to methods and systems that provide user access to computer resources with controlled user access rights to the computer resources.

2. Description of Related Art

Network environments often involve a variety of network users, where the users may be grouped or categorized by a relation or role that the user serves in the environment. For example, in an engineering or technical development company environment, users of the company's computer network may include company officers, directors, managers, engineers, technical support staff, office support staff, accounting department staff, information technology (IT) department staff, contractors, consultants, temporary employees or other relation-based or role-based groups or categories of network users.

Other companies, organizations or network environments may have other relation or role-based groups of users. Each user may have a need to access certain network resources in connection with the user's relation or role. In addition, it may be desirable to restrict users with certain relations or roles from access to certain resources, for example, for security, privacy or other reasons.

Depending on the network environment, other types of resources may also be allocated to (or restricted from) users, based on the user's relation or role in the environment. For example, in the engineering or development company environment described above, users may be allocated such resources as telephones, telephone accounts, computers, Internet accounts, e-mail accounts, office equipment and supplies, laboratory or engineering equipment and supplies, or other resources, based on the user's role or relation with the company.

In many conventional businesses or organizations, specific personnel perform the function of provisioning users according to their roles. For example, an office administrator may place an order with the organization's IT department to have a computer, telephone, voice mail, e-mail, and certain applications and databases available on the day a new user joins the organization. Individuals from the IT department would then manually set up these resources. Other office personnel may bring desks, chairs, and cabinets from storage and set up the user's office. Over the course of time, the user's relationship or roles within the organization may change, for example, as the user is transferred, promoted, demoted or terminated from the organization. As a user's relationship or role with the organization changes, the user's needs or rights to access resources may change.

The burden on the office administrator and office personnel to manually administer user access to resources in the above example is typically dependent on the size of the organization (the number of users) and the rate at which users join or leave the organization or otherwise change roles. To improve efficiency and reduce the burden on the office administrator and office personnel, some organizations have used software applications which automate or partially automate some of the tasks relating to provisioning certain, limited types of resources to users.

Role Based Access Control (RBAC) is one form of automatic provisioning that has become commercially available. RBAC provides permissions (access rights) to a user to access certain accounts (files, web pages, etc.) available over the network, based on a person's role in the organization. For example, a file or folder may be viewed only by its creator, or may be accessible to a larger group of users through an organization's network, depending on the permission rights established for that file or folder. In conventional RBAC systems, these permissions are based on a person's role within the organization.

However, modern organizations may be structured along several intersecting lines. For example, organizations may be structured according to title (presidents, vice-presidents, directors, managers, supervisors, etc.), technology (electronics, mechanical, software, etc.), project (product A, B, C, etc.), location (Irvine, N.Y., etc.) and the like. A single user may appear in several or all of these organizational structures, and thus may be in a somewhat unique overall role as compared to other users in the organization. Because this may require that many users be provisioned uniquely, many unique roles would have to be defined in the system to automate such provisioning. Furthermore, conventional RBAC only provisions “soft” resources such as accounts, applications, databases, files, Web pages, and the like, as opposed to “hard” resources such as telephones, computers, desks, and the like.

There is a need for methods and systems that provide users access to computer resources that does more than only considering security profiles assigned to roles of users. There is another need for methods and systems that provide users access to computer resources that factor assignments to business processes. Yet there is another need for methods and systems that provide users access to computer resources that includes risk assessments.

### SUMMARY OF THE INVENTION

Accordingly an object of the present invention is to provide methods and systems that enables the provision of access by users to computer resources that does more than only considering security profiles assigned to roles of users.

Another object of the present invention is to provide methods and systems that provide users access to computer resources that utilize assignments to business processes.

A further object of the present invention is to provide (provide twice) methods and systems that enables the provision of access by users to computer resources that includes risk assessments.

These and other objects of the present invention are achieved in a method of providing correct access to computer system resources. Correct access is based on a description of business processes, roles, and the assignment of roles to business processes. Such a definition is stored in an enterprise model. To compute the correct security profiles, the model is analyzed to identify security profiles that meet role and business process assignments for each user of the computer system. An iteration is done through possible security profiles to identify potential best matches of profiles that provides access to the resources required to implement the business process by one or more users. A subset of the security profiles is created on the associated business processes response based on the lowest risk assessments.

In another embodiment of the present invention, a method of providing access to network resources collects relevant process for a user of the network resources. Business processes are collected that provide authorization for the relevant processes. Iteration over business processes is used to identify a best match. A subset is created of the business processes that determines the relevant processes with the lowest risk assessment. Recommended profiles are created from the subset of business processes.

In another embodiment of the present invention, a system provides access to network resources and includes a data server for storing a plurality of information relative to an enterprise model. First resources analyze the enterprise model to identify security profiles that meet role and business assignments for each user of the enterprise model. Second resources iterating through possible security profiles to identify a best match. Third resources create a subset of the business processes based on lowest risk assessments. Fourth resources create recommended security profiles for the users.

### BRIEF DESCRIPTION OF THE FIGURES

FIG. 1 is a flow chart illustrating one embodiment of the risk assessment logic of the present invention.

FIG. 2 is a block diagram illustrating of one embodiment of a system of the present invention.

FIG. 3 is a block diagram illustrating the application server and an associated repository in one embodiment of a system of the present invention.

### DETAILED DESCRIPTION OF THE PREFERRED EMBODIMENT

Various embodiments of the present invention provides methods, and their corresponding systems, that enable optimal grants of access of users to computer system resources. An organization has users of its computer resources that have at least one or more job functions with responsibility for at least a portion of a business process. The organization's users require access to computer resources to perform their job junctions.

Computer system resources include physical hardware devices such as desktop and server computers, networks, storage devices, and printers as well as software resources such as desktop and server applications or individual software components that are the basis for larger computer systems. In various embodiments, the computer system resources can be associated with a computer system including but not limited to, a local or networked software application such as: Enterprise Resource Planning, Customer Relationship Management, Product Lifecycle Management, Supply Chain Management, Procurement, eBusiness, Business-to-Business, and Business-to-Consumer, and the like.

An enterprise model is analyzed to identify security profiles that meet role and business process assignments for each user of the computer system. Analyzing the enterprise model can include, identifying users, roles, business processes, systems, and security profiles of the computer system.

In various embodiments, the enterprise model can describe at least one of, users, user roles, business processes, systems, applications, security profiles, geographical distribution, system interfaces, and data exchange formats for an organization. An iteration is done through possible security profiles to identify potential optimal matches. In one embodiment, best matches are identified using risk assessment logic. The optimal matches could also be identified by on geography or frequency of use.

The risk assessment logic rates computer resources in terms of access and a risk to the organization. For example, the risk of providing access to the mechanism for updating confidential employee data is much greater than providing access to the mechanism for organizing electronic diaries. Each component has an associated risk. The risk assessment logic assesses risk factors of components of the enterprise model and performs a security analysis on business processes.

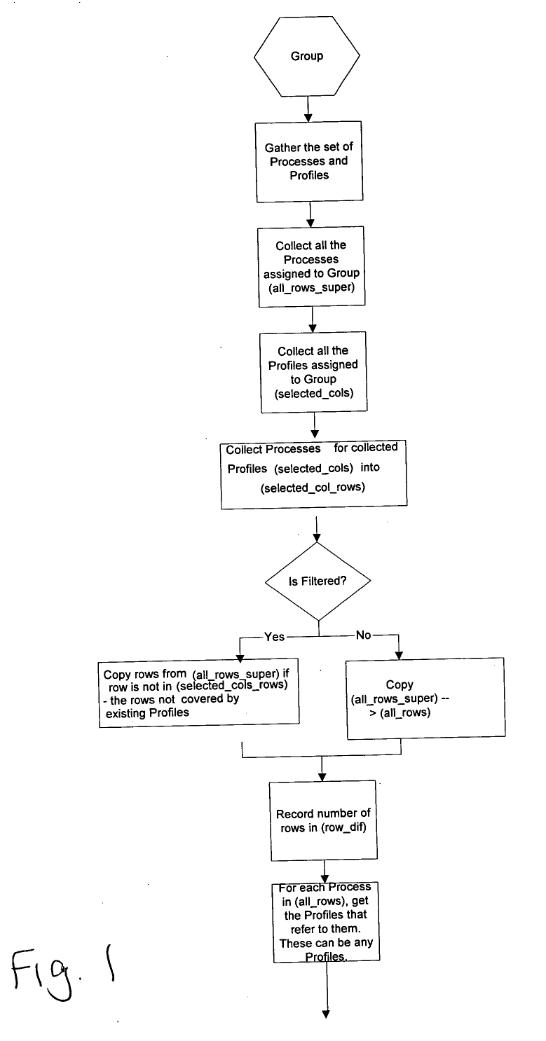

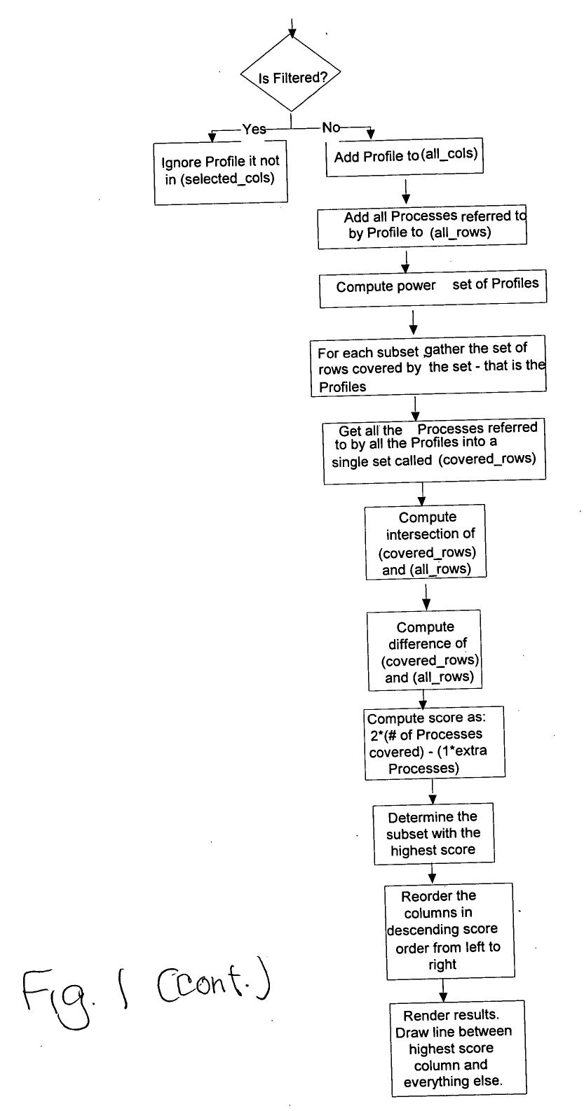

FIG. 1, illustrates one embodiment of risk assessment logic of the present invention. Objects are related to process objects in that is a particular group must perform some number of processes. Users are assigned to groups and each user does some part of the group's work. The input to the logic resources is a group. A filter can be specified as either “on” or “off”. When on, the filter has the effect of causing only the remaining rows that are not in profiles assigned to the group to be displayed.

The set of processes and profiles are gathered. All the processes are collected that are assigned to the input group. These become matrix rows at the top part of the matrix and are then stored.

All of the profiles that are assigned to the input Group are then collected and stored in selected columns. All the processes that the profiles in (selected_cols) refer to are then collected and stored in selected rows and columns.

If the filter is off, logic resources stores all the rows from (all_rows_super) into (all_rows). If the Filter is on, logic resources stores only the rows from (all_rows_super) that are not in (selected_cols_rows) which are the rows that are not covered by existing Profiles.

The number of rows is stored into (row_dif) at this point. This defines the division between the rows that are needed to cover versus the rows that are added as extra by including Profiles in Step 7. A set of cols in (all_cols) is stored as follows: for all the rows (Processes) in (all_rows), get the cols (Profiles) that refer to them. There can be any Profiles in the model, not just the ones already assigned to the Group. If the filter is on and the column (Profile) is not in (selected_cols), ignore it.

If the filter is off, the column (Profile) is added to the (all_cols). All the rows (Processes) that column refers to (all_rows) are added. The power set of columns (Profiles) is computed. This is the set of all subsets of the columns. For each subset in the power set, the set of rows covered by the set are retrieved. That is, each item in the subset is a Profile. All of the rows (Processes) referred to by all the Profiles are retrieved into a single set that is called the (covered_rows). The intersection of (covered_rows) and (all_rows) is determined. The difference between the (covered_rows) and the (all_rows). The score is 2 times the number of elements in the intersection minus 1 times the number of elements in the difference. That is:
score=(2*# processes covered)−(1* extra processes).

The subset with the highest score is identified. The columns are recorded so that the columns (Profiles) in the subset with the highest score are the left-most columns of the table. A vertical line is then drawn to the right of this set. The remaining columns are placed to the right of the vertical line.

A subset of the security profiles is created on the associated business processes response based on the lowest risk assessments. The subset includes security profiles to specific accesses for functionality required by a user. Security profiles provide access to resources for users. Examples of security profiles include but are not limited to, a username/password pair used for access a desktop computer, a username/password pair used for accessing a software application, a software security profile that limits the ability for a user (or group of users) to specific functions within a software application, or a security profile that limits the data processing of one or more functions within a computer system. Recommended security profiles are created for the users.

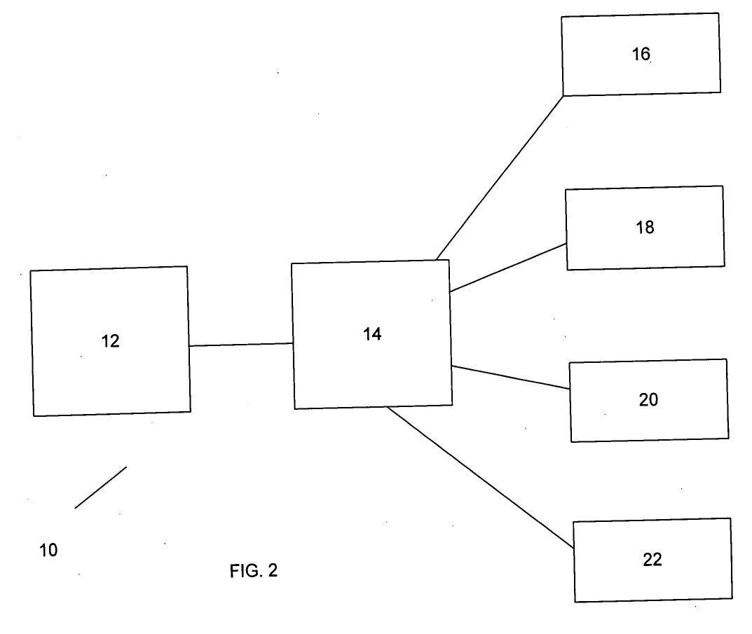

Referring now to FIG. 2, a system 10 is illustrated that is operable on a computer system to identify the profiles, grants of access to the computer resources and best match the resource requirements associated with the processes that the user, group and/or organization perform. System 10 can be implemented with software applications and modules deployed on various processor or computer systems connected for communication over one or more network or non-network links the processors in which the modules and applications are deployed may differ from system embodiment to system embodiment. In addition, the types of users, administrators and other entities that interact with the system may differ from system embodiment to system embodiment.

In one embodiment of the present invention, system 10 provides access to network resources, generally denoted as 12, and includes an application server 14 for storing a plurality of information relative to an enterprise model. First resources 16 analyze the enterprise model to identify security profiles that meet role and business assignments for each user of the enterprise model. Second resources 18 iterate through possible security profiles to identify a best match. Third resources 20 create a subset of the business processes based on lowest risk assessments. Fourth resources 22 create recommended security profiles for the users.

System 10 can include applications and modules that are organized into system components. A component is a self-contained and independent software entity that can be deployed onto computer and networking hardware separately from other components within system 10.

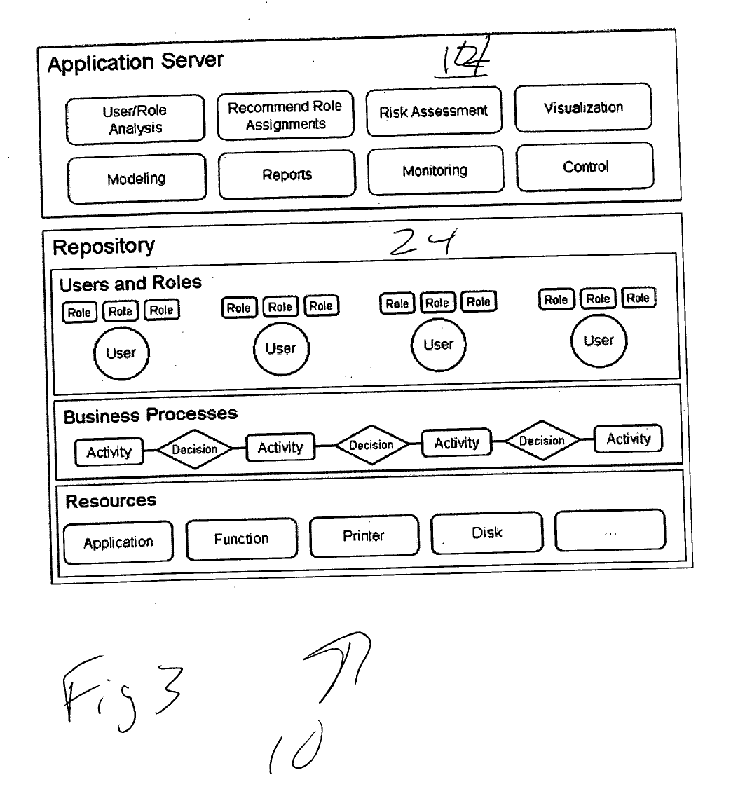

In one embodiment, illustrated in FIG. 3, application server 14 includes capabilities for, user/role analysis, recommendation of role assignments, risk assessments, visualization, modeling, reports, monitoring, control and the like. Application server component can use secure connections, such as secure remote method invocation (RMI) connections, and the like.

A repository 24 is provided. Repository 24 includes information relative users and their roles, business processes and associated resources. Business processes can include various activities and associated decisions. The resources can include applications, functions, printers, disks and the like.

The responsibility of configuring system 10 deployment may be provided to a system administrator. Thus, applications, modules or components containing groups of applications or modules as described above may be provided to a system administrator, for example, in software form (such as on a computer readable storage medium), in hardware or firmware form (such as on circuit boards or cards to be installed in a computer system) or a combination thereof. The system administrator may then develop a deployment strategy that meets the organization's performance and security needs and deploy the appropriate modules on appropriate hardware devices to fit the desired strategy. The system administrator may be free to deploy all of the components of the system on one processor or distribute clusters of each component in almost any combination, if desired.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A method of providing correct access to computer system resources, comprising:
(a) analyzing an enterprise model to identify security profiles that meet role and business process assignments for each user of the computer system;
(b) iterating through possible security profiles to identify a potential best matches
(c) creating a subset of the security profiles based on the associated business processes based on the lowest risk assessments; and
(d) creating recommended security profiles for the users.

2. The method of claim 1, wherein analyzing the enterprise model includes identifying users, roles, business processes, systems, and security profiles of the computer system.

3. The method of claim 1, wherein the enterprise model describes at least one of, users, user roles, business processes systems, applications, and security profiles for an organization.

4. The method of claim 3, wherein the organization includes users with at least one or more job function with responsibility for at least a portion of a business process, wherein the users require access to computer resources to perform their job junctions.

5. The method of claim 4, wherein the computer resources include at least one of a, computer system resource

6. The method of claim 5, wherein the computer system is selected from at least one of a local or networked software application such as: Enterprise Resource Planning, Customer Relationship Management, Product Lifecycle Management, Supply Chain Management, Procurement, eBusiness, Business-to-Business, and Business-to-Consumer.

7. The method of claim 6, wherein the computer system is used in its entirety or in part.

8. The method of claim 1, wherein the subset includes security profiles to specific accesses for functionality required by a user.

9. The method of claim 1, wherein a security profile is an access to a resource for a user.

10. The method of claim 1, wherein the best match is identified using risk assessment logic.

11. The method of claim 10, wherein the risk assessment logic rates computer resources in terms of access and a risk to the organization.

12. The method of claim 11, wherein each component has an associated risk.

13. The method of claim 11, wherein the risk assessment logic assesses risk factors of components of the enterprise model.

14. The method of claim 10, wherein the risk assessment logic performs a security analysis on business processes.

15. The method of claim 10, wherein the risk assessment logic looks at a set of processes associated with a business process that is outside a set of relevant processes.

16. The method of claim 10, wherein the risk assessment logic assigns a risk assessment score to each business process in response to a severity of an over authorization.

17. The method of claim 10, wherein a matrix of business processes and relevant processes is populated with risk assessment scores.

18. The method of claim 1, wherein the recommended profiles are presented to an administrator for review.

19. A method of providing access to network resources, comprising:
(a) collecting relevant process for a user of the network resources;
(b) collecting business processes that provide authorization for the relevant processes
(c) iterating over business processes to identify a best match;
(d) creating a subset of the business processes that determines the relevant processes with the lowest risk assessment; and
(e) creating recommended profiles from the subset of business processes.

20. The method of claim 19, further comprising:
analyzing an enterprise model by identifying users, roles, business processes, systems, and security profiles of the network resources.

21. The method of claim 20, wherein the enterprise model describes at least one of, users, user roles, business processes, systems, applications, and security profiles for an organization.

22. The method of claim 21, wherein the organization includes users with at least one or more job function with responsibility for at least a portion of a business process, wherein the users require access to computer resources to perform their job junctions.

23. The method of claim 22, wherein the computer resources include at least one of a, computer system resource

24. The method of claim 23, wherein the computer system is selected from at least one of a local or networked software application such as: Enterprise Resource Planning, Customer Relationship Management, Product Lifecycle Management, Supply Chain Management, Procurement, eBusiness, Business-to-Business, and Business-to-Consumer.

25. The method of claim 24, wherein the computer system is used in its entirety or in part.

26. The method of claim 19, wherein the subset includes security profiles to specific accesses for functionality required by a user.

27. The method of claim 20, wherein a security profile is an access to a resource for a user.

28. The method of claim 19, wherein the risk assessment logic rates computer resources in terms of access and a risk to the network resources.

29. The method of claim 20, wherein each component of the enterprise model has an associated risk.

30. The method of claim 29, wherein the risk assessment logic assesses risk factors of components of the enterprise model.

31. The method of claim 29, wherein the risk assessment logic performs a security analysis on business processes.

32. The method of claim 29, wherein the risk assessment logic looks at a set of processes associated with a business process that is outside a set of relevant processes.

33. The method of claim 29, wherein the risk assessment logic assigns a risk assessment score to each business process in response to a severity of an over authorization.

34. The method of claim 29, wherein a matrix of business processes and relevant processes is populated with risk assessment scores.

35. The method of claim 19, wherein recommended profiles are presented to an administrator for review.

36. A system of providing access to network resources, comprising:
(a) a data server for storing a plurality of information relative to an enterprise model;
(b) first resources for analyzing the enterprise model to identify security profiles that meet role and business assignments for each user of the enterprise model;
(c) second resources for iterating through possible security profiles to identify a best match;
(d) third resources for creating a subset of the business processes based on lowest risk assessments; and
(e) fourth resources for creating recommended security profiles for the users.

37. The system of claim 36, further including a user interface for inputting information relative to the enterprise model.
